(19) United States
(12) Patent Application Publication
(10) Pub. No.: US 2023/0266041 A1
(43) Pub. Date: Aug. 24, 2023

(54) POWER ELECTRONICS ASSEMBLY AND DOMESTIC APPLIANCE

(71) Applicant: STIEBEL ELTRON GMBH & CO. KG, Holzminden (DE)

(72) Inventors: Carsten HUEGE, Wehretal (DE); Arkadiusz WAWER, Wehretal (DE)

(73) Assignee: STIEBEL ELTRON GMBH & CO. KG, Holzminden (DE)

(21) Appl. No.: 18/108,992

(22) Filed: Feb. 13, 2023

(30) Foreign Application Priority Data
Feb. 23, 2022 (DE) 102022104244.8

(51) Int. Cl. F24H 15/407; F24H 9/20; F24H 15/37; F24H 15/156; H01H 47/32

(52) U.S. Cl. CPC F24H 15/407; F24H 9/2021; F24H 15/37; F24H 15/156; H01H 47/325; F24H 2250/02

(57) ABSTRACT

A power electronics assembly of a domestic appliance includes a first relay controlling an electrical contact between a first current-carrying conductor and an electric consumer. The assembly further includes a semiconductor switching element that switches the electrical contact between the first current-carrying conductor and the electric consumer and is arranged in parallel with the first relay. A controller is programmed to activate the semiconductor switching element to switch on the electrical consumer before the first relay is closed.

### CROSS-REFERENCE TO RELATED APPLICATIONS

This application claims priority to German Patent Application No. DE 102022104244.8 filed Feb. 23, 2022, the disclosure of which is hereby incorporated in its entirety by reference herein.

### TECHNICAL FIELD

The present invention relates to a power electronics assembly for domestic appliances, such as storage water heaters as well as storage water boilers, and to a corresponding domestic appliance.

### BACKGROUND

Electric hot water appliances are often used to provide heated or hot potable water for daily use. Two types of hot water appliances include instantaneous water heaters (tankless) and storage water heaters, which include a tank. In both cases, an electric current flowing through heating element(s) can be used to heat drinking water.

Storage water heaters have a reservoir or tank in which a certain volume of drinking water is permanently provided at a set temperature. The tank is thermally insulated to minimize heat losses when providing the hot water.

The control or regulation of the electrical power can be carried out via a relay that is able to switch ON or OFF the connected electrical consumer, i.e., the heating element. A relay has the advantage that it makes almost lossless electrical contact in the closed state, so that even larger currents, such as those used to heat water, can be processed without significant losses. This has the advantage, in particular in the case of storage water heaters, that there are no heat losses through the switching element and thus no efficiency losses of the hot water appliance.

However, a significant disadvantage is that erosive wear occurs during each switching operation, for example, due to sparking when the switching contacts are move towards/away from each other. This results in a load- or current-dependent service life switching cycle number that is significantly, i.e., several orders of magnitude, lower than the theoretical mechanical service life.

For example, the mechanical service life of a common print relay suitable for installation on printed circuit boards with a rated current of 16 A is over 10⁷ switching cycles. Already at a current of 13 A, the electrical service life is only in the order of 10⁵ switching cycles.

### SUMMARY

The maximum number of switching cycles under load for an electrical heating appliance, e.g., hot water appliances such as quick heaters, storage water heaters, water boilers, is equivalent to a permissible controller switching hysteresis for a desired service life of the appliance. In this context, a larger number of switching cycles is equivalent to a possible lower hysteresis and vice versa—the achievable temperature control quality of the appliance depends directly on this hysteresis and thus on the number of switching cycles.

Purely electronic semiconductor switching elements, such as transistors, thyristors or so-called TRIACs, which do not require any mechanically moving parts, may also be used to control hot water appliances. Accordingly, they are not subject to mechanical wear, but have a comparatively high contact resistance and therefore produce current-proportional losses at precisely this resistance, which leads to heating during operation. This power loss may be dissipated via cooling mechanisms to avoid excessive heating of the semiconductor. While the dissipation, for example, in the case of instantaneous water heaters, can be carried out easily via the flowing water to be heated, the dissipation of the power loss is more difficult in the case of heavily insulated storage water heaters.

In view of the above-noted issues, this disclosure describes a power electronics assembly of a domestic appliance that enables a long service life of the domestic appliance with high ease of use and high efficiency.

In one aspect, a power electronics assembly of a domestic appliance, e.g., a hot water appliance such as a quick heater, a storage water heater, a water boiler includes a first relay controlling an electrical contact between a first current-carrying conductor and an electrical consumer. The electrical consumer may be an ohmic consumer, such as a heating element, of the domestic appliance, a semiconductor switching element that switches the electrical contact between the first current-carrying conductor and the electrical consumer and is arranged in parallel with the first relay, and a controller programmed to activate the semiconductor switching element to switch on the electrical consumer before the first relay is closed.

Due to the parallel arrangement and skillfully timed activation according to the invention of the relay and the semiconductor switching element, the voltage across the first relay at the time of closing of the first relay is in the low range, for example less than 1 V, so that the relay can be switched in a quasi power-free manner. As a result of the quasi power-free switching of the relay, burn-off is avoided and the service life of the relay can be increased.

The inventors of the present disclosure have found that the number of switching cycles can be increased by at least a factor of ten by supporting the semiconductor switching element. Experiments have shown a number of over 3 million switching cycles for commercially available relays for domestic appliances.

The resistance across the semiconductor switching element can be, for example, 20 mΩ in the conductive state. Since the line resistance of the closed first relay is much lower, almost all of the current to the electrical consumer after the closing of the first relay will flow through the first relay and not the semiconductor switching element. This prevents the power loss that occurs almost exclusively at the semiconductor switching element.

The electrical consumer may be an ohmic heater, for example a tubular heater or a bare wire heater.

The increase in service life switching cycles according to this disclosure can result in two main improvements to the domestic appliance. First, the service life of the domestic appliance can be extended if the previous switching intervals are maintained. This assumes that the other components of the domestic appliance are suitable for a longer service life.

Additionally, increasing the service life switching cycles of the first relay can be used to allow more frequent switching. For example, the frequency of switching ON or OFF of the relay is set by hysteresis limits. The improvements of this disclosure allow maintaining a hysteresis of 2 K or even less than 2 K. This is accompanied by an increase in comfort since the desired temperature is maintained with a higher degree of accuracy.

According to this disclosure, a quality is achieved that previously required the exclusive use of semiconductor switching elements with the unavoidable power losses associated therewith. Power losses are avoided by the first relay provided according to this disclosure.

Accordingly, the invention makes it possible to combine the advantages of lossless relays and of wear-free semiconductor switching elements in order to enable a higher overall comfort of the domestic appliance without compromising the efficiency and thus the cost effectiveness of the domestic appliance.

The controller may be further programmed to stop the activation of the semiconductor switching element after the first relay has closed.

When the first relay is closed, only negligible power is passed through the semiconductor switching element so that it is not necessary for the semiconductor switching element to be conductive; rather, the closed position of the first relay is sufficient for the operation of the electrical consumer.

In this embodiment, by stopping the activation of the semiconductor switching element after the first relay has closed, the controller does not need to continuously provide a control current to the semiconductor element, so that the overall efficiency of the domestic appliance is improved.

The power electronics assembly may further comprise a second relay that controls an electrical contact between a second current-carrying conductor and the electrical consumer, wherein the controller is programmed to close the second relay to switch on the electrical consumer before the semiconductor switching element is activated.

The second relay may be connected to the second current-carrying conductor. Domestic appliances may be connected in a low-voltage network that has two active or current-carrying conductors, such as a neutral conductor and a phase-carrying line conductor.

Accordingly, the second relay enables reliable disconnection, because regardless of the connection orientation in the low-voltage network, i.e., regardless of whether the phase forms the second current-carrying conductor or the first current-carrying conductor, the phase can be disconnected by the first relay or the second relay.

If the second relay is closed before the semiconductor switching element is activated and consequently also before the first relay is closed, the closing of the second relay does not result in the closing of an electric circuit via the electric consumer so that the closing of the second relay is voltage-free and burn-off-free. For this reason, it is not necessary to also provide a semiconductor switching element in parallel with the second relay.

The controller may be programmed to activate the semiconductor switching element before the first relay opens in order to switch OFF the electric consumer.

In the reverse order of switching on, in preparation for switching OFF, it is ensured that the first relay can be opened in an almost wear-free manner by closing the electric circuit via the semiconductor switching element connected in parallel.

Preferably, the control system is configured to stop the activation of the semiconductor switching element after the first relay has opened and, in particular, before the second relay has opened in order to switch OFF the electric consumer.

Accordingly, since the electric circuit is already disconnected before the second relay has opened, the second relay can also be opened in a power-free and thus burn-off-free manner.

The semiconductor switching element may be a TRIAC.

TRIACs have a control electrode G (gate) that is in communication with the controller. When ignition current is applied to the control electrode G, a load current is ignited between two main electrodes of the TRIAC. The TRIAC remains conductive until the holding current is no longer reached. Other semiconductor switching elements can also be used.

The first and/or the second relay may be configured as relays with a monostable switching state.

For example, the relays are open accordingly as long as they are not energized by the controller. This has the advantage that the control current for closing the relay must be applied so that there is a current-carrying contact to the electrical consumer. Therefore, in the event of a fault, the corresponding relays are open and the unwanted flow of the electric current can be prevented.

The power electronics assembly may further include a galvanic isolation between the current-carrying conductor(s) and the controller.

The power electronics assembly may further include a fusible link in a connection line of the controller and/or a smoothing capacitor between connection lines of the controller.

In another aspect, a domestic appliance e.g., a hot water appliance such as a quick heater, storage water heater, water boiler, may include a power electronics assembly according to this disclosure.

Accordingly, the domestic appliance allows obtaining the same advantages as described for the power electronics assembly. Also, it can be combined with the configurations described while achieving the same advantages.

### BRIEF DESCRIPTION OF THE DRAWINGS

FIG. 1 schematically illustrates an exemplarily circuit diagram of a power electronics assembly.

FIG. 2 schematically shows exemplarily circuit diagram for switching the electrical consumer ON and OFF.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

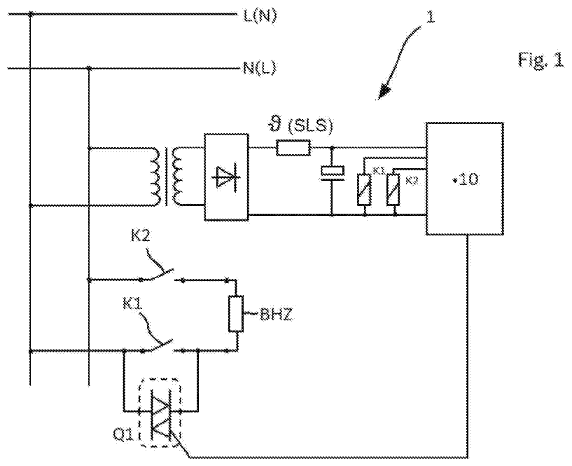

FIG. 1 shows schematically and by way of example a circuit diagram of a power electronics assembly 1 according to one or more embodiments of this disclosure. The power electronics assembly 1 is designed, for example, as an assembly of a domestic appliance, e.g., a hot water appliance, such as a quick heater, storage water heater, water boiler, and controls or regulates the activation of an electric consumer BHZ, for example, a tubular heater or a bare wire heater.

The power electronics assembly 1 or the entire domestic appliance is connected to two current-carrying conductors, for example, of a low-voltage network, which are referred to herein as phase or conductor L, and neutral conductor N. The possibility of a reverse connection, which is easily possible according to the disclosure, is indicated in brackets.

The electrical consumer BHZ is arranged between the two conductors L, N and can be disconnected or connected in each case by an upstream relay K1 or K2 in the first conductor L or the second conductor N, respectively. This ensures that the voltage-carrying phase, i.e., the L conductor, is disconnected before the BHZ electrical consumer when both are connected.

A semiconductor switching element Q1 is arranged in parallel with the relay K1 in the first conductor L. The semiconductor switching element Q1 is preferably configured as a TRIAC.

A regulator or controller 10 is arranged galvanically isolated from the conductors L, N. All known types of galvanic isolation are conceivable here, of which only one is shown as an example in the circuit diagram.

The controller 10 may be designed to close the relay K1 and the relay K2. The relay K1 and/or the relay K2 may be relays with a monostable switching state so that the relay or relays are open when no control current provided by the control 10 is applied. The relay(s) is/are closed only when the control current is applied.

A fusible link SLS and a smoothing capacitor may be provided upstream of the control 10.

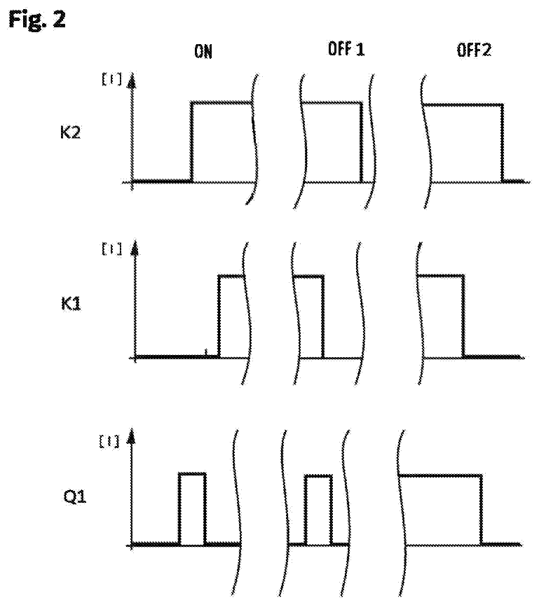

Switching on the electrical consumer BHZ is carried out in the following switching sequence, which is also shown schematically in FIG. 2 under the heading “ON”.

1. Closing of relay contact K2.

This is done without current since the electric circuit is not yet closed in this case due to the initially still open contacts of the relay K1 and the semiconductor switching element Q1.

2. Closing/activating the semiconductor switching element Q1.

The semiconductor switching element Q1 closes the electric circuit, the heater or electrical consumer BHZ starts to heat.

3. Closing of the relay contact K1

The relay K1 bridges the semiconductor switching element Q1 and takes over the current flow—in this case, there is no significant load on the relay contact since only a minimal differential voltage has to be bridged at the moment of switching on and the residual current already flows via the semiconductor switching element Q1.

4. Opening the semiconductor switching element Q1

This step is optional since the semiconductor switching element Q1 becomes non-conductive as soon as the relay K1 is closed—however, the continuous activation is unnecessary.

Switching OFF is done analogously in reverse order, wherein two alternatives are shown for this purpose in FIG. 2, which are marked with OFF1 and OFF2.

1. Closing/activating the semiconductor switching element Q1

While in alternative OFF1, the semiconductor switching element Q1 is first opened and then closed in a first step; in alternative OFF2, the semiconductor switching element Q1 is permanently activated during operation of the electrical consumer BHZ. Thus, with alternative OFF2, the optional step 4 has not been executed during switch-on.

2. Opening of relay contact K1

By opening the relay K1, the activated or closed contact takes over the current from the relay K1 via the semiconductor switching element Q1, wherein the relay K1 can be opened without burn-off due to the closed or conducting semiconductor switching element Q1.

3. Opening of the semiconductor switching element Q1

Opening of the semiconductor switching element Q1 takes place without wear. With that, the switching circuit is opened and the current flow is stopped.

4. Opening of the relay contact K2.

Since the switching circuit is already open, relay K2 can now also be opened in voltage-free and wear-free manner.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A power electronics assembly of a domestic appliance comprising:
a first relay controlling an electrical contact between a first current-carrying conductor and an electric consumer of the domestic appliance;
a semiconductor switching element that switches the electrical contact between the first current-carrying conductor and the electric consumer and is arranged in parallel with the first relay; and
a controller programmed to activate the semiconductor switching element to switch ON the electric consumer before the first relay is closed.

2. The power electronics assembly according to claim 1, wherein the controller is further programmed to stop the activation of the semiconductor switching element after the first relay has closed.

3. The power electronics assembly according to claim 1 further comprising a second relay controlling an electrical contact between a second current-carrying conductor and the electric consumer, wherein the controller is further programmed to close the second relay to switch ON the electric consumer before the semiconductor switching element is activated.

4. The power electronics assembly according to claim 1, wherein the controller is further programmed to activate the semiconductor switching element before the first relay has opened in order to switch OFF the electric consumer.

5. The power electronics assembly according to claim 4, wherein the controller is further programmed to stop the activation of the semiconductor switching element after the first relay has opened and before the second relay has opened in order to switch OFF the electric consumer.

6. The power electronics assembly according to claim 4, wherein the controller is further programmed to stop the activation of the semiconductor switching element after the first relay has opened in order to switch OFF the electric consumer.

7. The power electronics assembly according to claim 1, wherein the semiconductor switching element includes a TRIAC.

8. The power electronics assembly according to claim 1, wherein the first relay includes a monostable switching state.

9. The power electronics assembly according to claim 3, wherein the first and the second relay each include a monostable switching state.

10. The power electronics assembly according to claim 1, further comprising a galvanic isolation between the current-carrying conductor(s) and the controller.

11. The power electronics assembly according to claim 1, further comprising a fusible link in a connection line of the controller or a smoothing capacitor between connection lines of the controller.

12. The power electronics assembly according to claim 1, wherein the electric consumer is an ohmic consumer.

13. The power electronics assembly according to claim 12, wherein the ohmic consumer is a heating element.

14. A domestic appliance comprising:
an electric consumer;
a first relay controlling an electrical contact between a first current-carrying conductor and the electric consumer;
a semiconductor switching element that switches the electrical contact between the first current-carrying conductor and the electric consumer and is arranged in parallel with the first relay; and
a controller programmed to activate the semiconductor switching element to switch ON the electric consumer before the first relay is closed.

15. The domestic appliance of claim 14, wherein the electric consumer is a heating element.

16. The domestic appliance of claim 14, wherein the controller is further programmed to stop the activation of the semiconductor switching element after the first relay has closed.

17. The domestic appliance according to claim 14 further comprising a second relay controlling an electrical contact between a second current-carrying conductor and the electric consumer, wherein the controller is further programmed to close the second relay to switch ON the electric consumer before the semiconductor switching element is activated.

18. The domestic appliance according to claim 17, wherein the controller is further programmed to activate the semiconductor switching element before the first relay has opened in order to switch OFF the electric consumer.

19. A hot water heater comprising:
an electric heating element;
a first relay controlling an electrical contact between a first current-carrying conductor and the heating element;
a semiconductor switching element that switches the electrical contact between the first current-carrying conductor and the electric consumer and is arranged in parallel with the first relay; and
a controller programmed to activate the semiconductor switching element to switch ON the heating element before the first relay is closed.

20. The hot water heater of claim 19, wherein the controller is further programmed to stop the activation of the semiconductor switching element after the first relay has closed.
